(19) United States
(12) Patent Application Publication
(10) Pub. No.: US 2004/0198400 A1
(43) Pub. Date: Oct. 7, 2004

(54) Method for inserting symbols in text messages using a cellular phone

(76) Inventor: Hsien-Chung Lin, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,376

(22) Filed: Apr. 3, 2003

(51) Int. Cl. H04Q 7/20; G09G 5/00

(52) U.S. Cl. 455/466; 455/412.1; 345/2.1; 345/2.3

(57) ABSTRACT

A method for inserting a symbol in a text message using a cellular phone. The cellular phone has a display panel for displaying data. The method includes dividing the display panel into a first display area for entering the text message and a second display area for listing a plurality of symbols. The method also includes inserting a symbol selected from the plurality of symbols into the text message.

### BACKGROUND OF INVENTION

1. Field of the Invention

The present invention relates to a method for inserting symbols in text messages, and more specifically, to a method for inserting a symbol in text messages using a cellular phone, the symbol not being mapped to a corresponding key on a keypad of the cellular phone.

2. Description of the Prior Art

It is becoming increasingly popular to use cellular phones to send messages to friends and relatives. Many users now use cellular phones to compose and send Short Message Service (SMS) messages, e-mail messages, Multimedia Messaging Service (MMS) messages, Personal Information Manager (PIM) messages, and so on. As the number of messages being composed and sent using cellular phones increases, it is important to make text input on a cellular phone as convenient as possible.

Please refer to FIG. 1. FIG. 1 is a diagram of a cellular phone 10 used for editing a text message 46 according to the prior art. The cellular phone 10 comprises a display 12, which is typically a liquid crystal display (LCD). The cellular phone contains a Send key 14, an OK key 16, a Cancel key 18, and a directional key 20. Furthermore, the cellular phone contains twelve standard telephone keys 22-44. In order to compose a message on the cellular phone 10, a user of the cellular phone 10 has to first enter an editing mode of the cellular phone 10. As shown on the display 12 in FIG. 1, the text message 46 containing the text “How are you” has been typed. A cursor 48 indicates where a next character will be typed in the text message 46.

Unfortunately, a problem comes when a user wants to enter symbols, such as punctuation marks and characters not in the English alphabet, into the text message 46. For example, after the string “How are you”, it is likely that the use would wish to enter a question mark “?”. Any characters that are mapped onto the twelve standard telephone keys 22-44, such as A, B, C, D, and so on, can easily be typed into the text message 46. However, for symbols that are not mapped onto the twelve standard telephone keys 22-44, additional steps have to be taken to enter the symbols in the text message 46. Entering symbols according to the prior art method is accomplished by pressing a trigger key, such as the # key 44. After the trigger key is pressed, a new form is shown on the display 12 for allowing a symbol to be chosen.

Please refer to FIG. 2A and FIG. 2B. FIG. 2A and FIG. 2B are diagrams showing a first method for choosing a symbol to be inserted into the text message 46 according to the prior art. After the trigger key is pushed, the contents of FIG. 2A are shown on the display 12. A first potential symbol to be chosen is a “−” character. To view other symbols, the directional key 20 can be used to navigate up and down (or left and right) through the list of choices. As shown in FIG. 2B, after the directional key 20 is pressed once, a next symbol “,” is shown. In this manner, the directional key 20 is pressed repeatedly until a character that the user wants to insert is shown. Once the desired character is shown, the OK key 16 can be pressed to enter the desired symbol into the text message 46. Typically, the characters are stored in a fixed order, and the user may have to press the directional key a very large number of times before the desired character can be chosen. Moreover, the user may not be able to remember the relative positioning of characters that he wants to enter, and may easily skip over the desired character while he is rapidly pressing the directional key 20.

Please refer to FIG. 3. FIG. 3 is a diagram showing a second method for choosing a symbol to be inserted into the text message 46 according to the prior art. If the cellular phone 10 is in editing mode when the trigger key is pushed, the contents of FIG. 3 are shown on the display 12. In the second method, 35 to 40 symbols are shown on the display 12, and the user chooses the desired symbol by using the directional key 20. The user can then enter the desired symbol into the text message 46 by pressing the OK key 16.

Each of the two methods for entering a symbol shown in FIG. 2A-2B and FIG. 3 require a new form to be shown on the display 12 for choosing a symbol to be in the text message 46. This means that when the user is composing a message in the editing mode form shown in FIG. 1 and the user presses the trigger key, the editing mode form is no longer shown, and instead the symbol selection form is shown on the display 12. This constant changing of the contents of the display 12 can make the eyes of the cellular phone 10 user feel tired after composing a long text message including many symbols. Constantly changing the shown form from editing mode to symbol selection mode is difficult on the eyes, and is an unnecessary step in adding symbols to the text message 46.

### SUMMARY OF INVENTION

It is therefore a primary objective of the claimed invention to provide a method for inserting a symbol in a text message using a cellular phone.

According to the claimed invention, a method for inserting a symbol in a text message using a cellular phone is introduced. The cellular phone has a display panel for displaying data. The method includes dividing the display panel into a first display area for entering the text message and a second display area for listing a plurality of symbols. The method also includes inserting a symbol selected from the plurality of symbols into the text message.

It is an advantage of the claimed invention that the editing mode of the cellular phone simultaneously displays the editing space and the symbol space with the plurality of symbols. The plurality of symbols can contain symbols most frequently chosen by a user of the cellular phone. Thus, the user can see characters located in the symbol space while the user is composing a message in the editing space, and can choose a symbol in the symbol space directly. Therefore, the user does not have to open a new form containing additional symbols if the user is inserting a symbol listed in the symbol space. Since the present invention method shows less forms when inserting symbols into text messages, less steps are required to enter a symbol and it is easier on the user's eyes.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a cellular phone used for editing a text message according to the prior art.

FIG. 2A and FIG. 2B are diagrams showing a first method for choosing a symbol to be inserted into the text message according to the prior art.

FIG. 3 is a diagram showing a second method for choosing a symbol to be inserted into the text message according to the prior art.

FIG. 4 is a diagram of a cellular phone used for editing a text message according to the present invention.

FIG. 5 is a flowchart illustrating the present invention method for inserting symbols into the text message.

FIG. 6 shows using the present invention to insert groups of symbols or pictures into text messages.

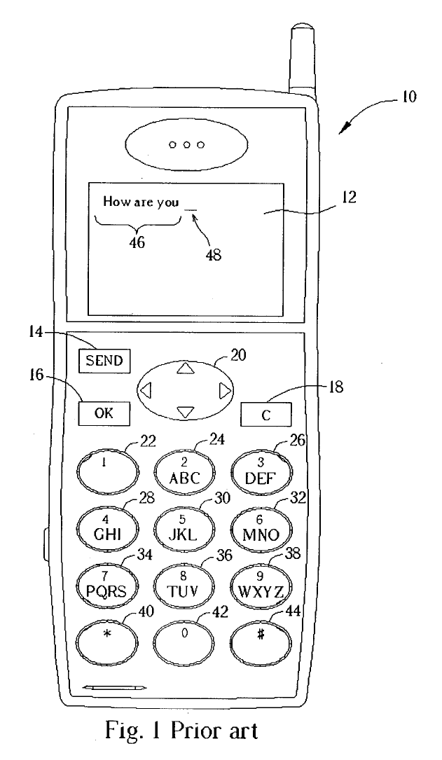

### DETAILED DESCRIPTION

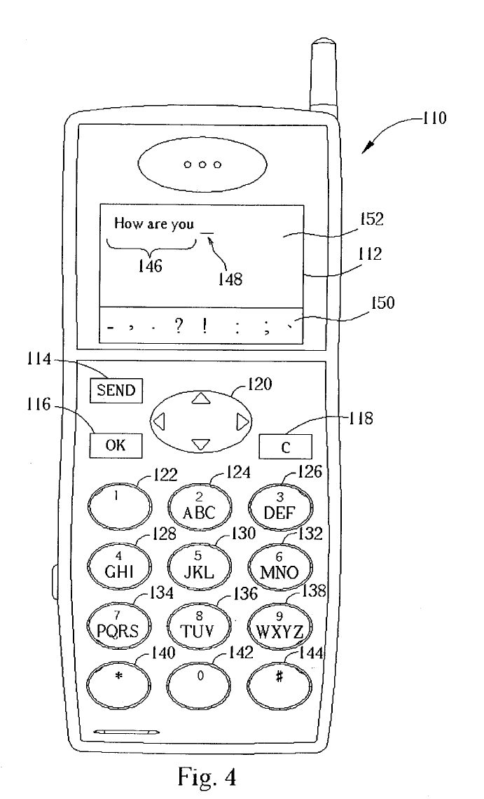

Please refer to FIG. 4. FIG. 4 is a diagram of a cellular phone 110 used for editing a text message 146 according to the present invention. The cellular phone 110 comprises a display 112, which is typically a liquid crystal display (LCD). The cellular phone contains a Send key 114, an OK key 116, a Cancel key 118, and a directional key 120. Furthermore, the cellular phone contains twelve standard telephone keys 122-144. In order to compose a message on the cellular phone 110, a user of the cellular phone 110 has to first enter an editing mode of the cellular phone 110.

Differing from the cellular phone 10 of the prior art, the display 112 of the present invention cellular phone 110 contains an editing space 152 and a symbol space 150. The editing space 152 is used for composing messages in the editing mode of the cellular phone 110. The symbol space 150 is for displaying a set of commonly used symbols such as punctuation symbols, and any other symbol that is not directly mapped to a key on the cellular phone 110. In a preferred embodiment of the present invention, the symbol space 150 contains 8 to 10 symbols. When in editing mode, the display 112 simultaneously shows the editing space 152 and the symbol space 150. With this setup, a user of the cellular phone 110 can easily select one of the symbols from the symbol space 150 while composing a message in the editing space 152 in editing mode.

The present invention teaches three options for selecting which symbols are shown in the symbol space 150. In the first option, the symbol space 150 can contain a fixed set of symbols. The makers of the cellular phone 110 choose this fixed set of symbols, and the symbols are selected according to which symbols are most commonly used in text messages. In the second option, the user of the cellular phone 110 is able to program exactly which symbols he would like shown in the symbol space 150. In the third option, a counter is used to keep track of how many times each symbol is inserted into text messages. The symbols that are chosen most frequently by the user for insertion into text messages are the symbols that are shown in the symbol space 150. Even though the symbol space 150 only contains 8 to 10 symbols, these 8 to 10 symbols are the most frequently used symbols. Therefore, a majority of the symbols inserted into text messages can be represented as a set of 8 to 10 symbols.

As shown on the editing space 152 in FIG. 4, the text message 146 containing the text “How are you” has been typed. A cursor 148 indicates where a next character will be typed in the text message 146. Since the text message 146 contains a question, it is likely that the user wishes to append a question mark “?” to the end of the text message 146. Because the question mark is one of the symbols shown in the symbol space 150, the question mark can be easily inserted into the text message 146 according to the present invention method of inserting symbols. In order to enter one of the symbols shown in the symbol space 150, first a trigger key has to be pressed while in editing mode. As an example, the Send key 114 will be used as the trigger key for the following disclosure. Once the trigger key has been pressed, the directional key 120 is used to choose one of the symbols shown in the symbol space 150, and pressing the OK key 116 inserts the symbol into the text message 146 shown in the editing space 152.

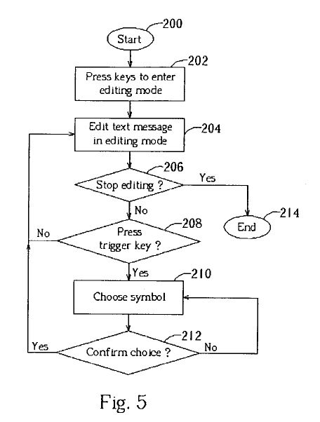

Please refer to FIG. 5. FIG. 5 is a flowchart illustrating the present invention method for inserting symbols into the text message 146.

Step 200:Start;

Step 202:Press appropriate keys on the cellular phone 110 to enter editing mode;

Step 204:Edit the text message 146 while in editing mode;

Step 206:Determine if the user has decided to leave the editing mode of the cellular phone 110 (the user can press the OK key 116 to indicate that the text message 146 is complete); if so, go to step 214; if not, go to step 208;

Step 208:Determine if the user has pressed the trigger key for choosing one of the symbols shown in the symbol space 150 (the Send key 114 can be used as the trigger key); if so, go to step 210; if not, go to step 204;

Step 210:The directional key 120 is used to choose one of the symbols shown in the symbol space 150 (for instance, the directional key 120 can be used to move left and right through the set of symbols in the symbol space 150);

Step 212:Determine if the choice of symbol is confirmed (if the user presses the OK key 116, the choice of symbol is confirmed; if the user presses the Send key 114, the choice of symbol is not confirmed); if so, go to step 204; if not, go to step 210; and

Step 214:End; the user is finished editing the text message 146.

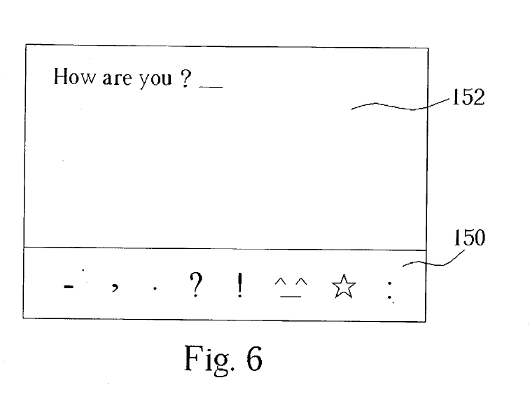

Please refer to FIG. 6. FIG. 6 shows using the present invention to insert groups of symbols or pictures into text messages. Another advantage of the present invention is that symbols stored in the symbol space 150 do not have to be single characters. Instead, groups of symbols such as \hat{ }_\hat{ } or pictures such as can also be used as symbols. These groups of symbols or pictures can be inserted into text messages just like any other symbol. Thus, if a user of the cellular phone 110 wished to enter the group of symbols \hat{ }_\hat{ } into a text message, he could enter the group all at once, saving considerable time over the alternative of adding three separate characters.

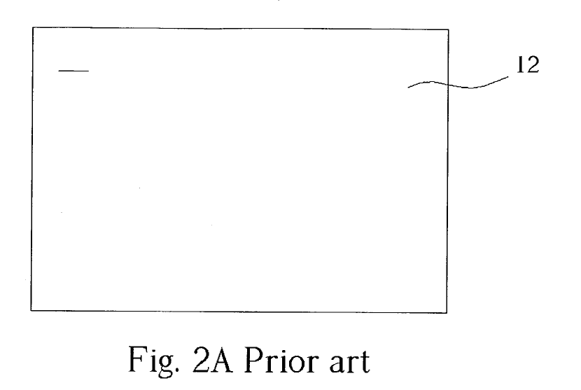

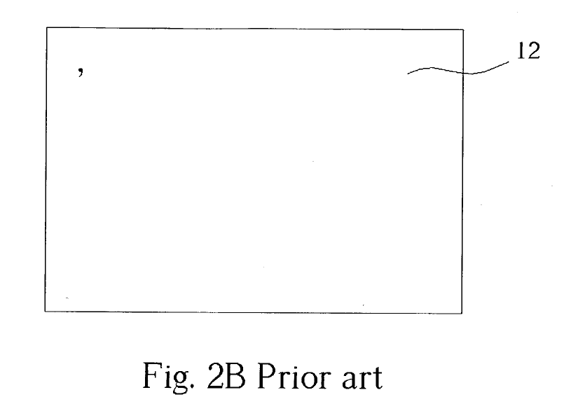

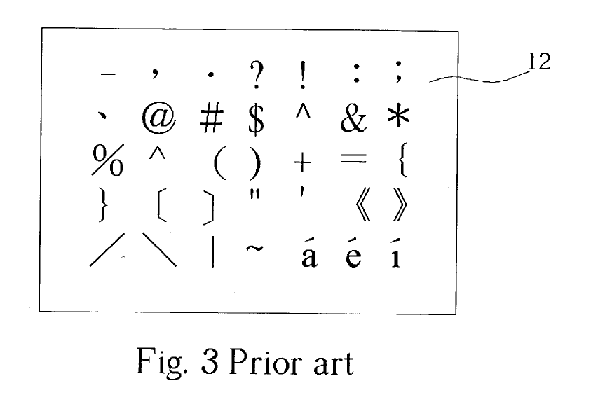

A majority of the symbols inserted into text messages by the user will likely come from the symbol space 150. However, if the symbol that the user wishes to enter is not shown in the symbol space 150, the user can select another symbol using either of the prior art methods shown in FIGS. 2A to 2B and in FIG. 3. Through the use of the symbol space 150, the present invention can provide easy access to common symbols when editing the text message 146. When the user wishes to enter one of the symbols located in the symbol space 150 into the text message 146, no additional forms need to be shown on the display 112 for selecting a symbol. Instead, the symbol can be selected directly from the symbol space 150 that is simultaneously displayed with the editing space 152. Since less forms are shown on the display 112 when inserting symbols into the text message 146, and it is easier on the user's eyes since the contents of the display 112 will not change frequently from one form to another. In addition, less steps are required when choosing a symbol from the symbol space 150 of the present invention than either of the two prior art methods shown in FIGS. 2A to 2B and in FIG. 3. This difference in steps becomes even more apparent when the symbol space 150 contains symbols chosen by the user or symbols used most frequently by the user.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for inserting a symbol in a text message using a cellular phone, the cellular phone having a display panel for displaying data, the method comprising following steps:
(a)dividing the display panel into a first display area for entering the text message and a second display area for listing a plurality of symbols; and
(b)inserting a symbol selected from the plurality of symbols into the text message.

2. The method of claim 1 wherein the plurality of symbols contains 8 to 10 symbols.

3. The method of claim 1 wherein the plurality of symbols is a fixed set of symbols comprising frequently used symbols.

4. The method of claim 1 wherein the plurality of symbols comprises a customizable set of symbols.

5. The method of claim 1 wherein the plurality of symbols comprises symbols that were selected most frequently.

6. The method of claim 1 wherein at least one of the symbols in the plurality of symbols contains a string of characters, the string of characters functioning as a single symbol.

7. The method of claim 1 wherein at least one of the symbols in the plurality of symbols contains a picture image, the picture image functioning as a single symbol.

8. The method of claim 1 wherein step (a) is performed when a key corresponding to the plurality of symbols is triggered.
